(19) United States
(12) Patent Application Publication
(10) Pub. No.: US 2025/0018939 A1
(43) Pub. Date: Jan. 16, 2025

(54) INFRASTRUCTURE COOPERATIVE AUTONOMOUS DRIVING SYSTEM AND METHOD OF GENERATING TRAJECTORY CONSTRAINTS FOR COLLISION AVOIDANCE IN AUTONOMOUS VEHICLES BY USING THE SYSTEM

(71) Applicant: Electronics and Telecommunications Research Institute, Daejeon (KR)

(72) Inventors: Jinhong NOH, Daejeon (KR); Jooyoung Kim, Daejeon (KR); Kyoung-Wook Min, Daejeon (KR); Yongwoo Jo, Daejeon (KR)

(73) Assignee: Electronics and Telecommunications Research Institute, Daejeon (KR)

(21) Appl. No.: 18/678,658

(22) Filed: May 30, 2024

(30) Foreign Application Priority Data
Jul. 11, 2023 (KR) 10-2023-0089892

(51) Int. Cl. B60W 30/095; B60W 60/00

(52) U.S. Cl. CPC B60W 30/0956; B60W 60/0027; B60W 2556/40; B60W 2556/45

(57) ABSTRACT

According to the present invention, autonomous driving may be performed according to an autonomous driving strategy defined in trajectory constraints generated based on object recognition information about a road map and various traffic participants, and thus, because collision avoidance does not obstruct traffic of an adjacent lane despite a situation where an autonomous vehicle stops for avoiding a collision, the stability of autonomous driving may increase and vehicle traffic management may be easily performed.

### CROSS-REFERENCE TO RELATED APPLICATIONS

This application claims the benefit of the Korean Patent Application No. 10-2023-0089892 filed on Jul. 11, 2023, which is hereby incorporated by reference as if fully set forth herein.

### BACKGROUND

### Field of the Invention

The present invention relates to collision avoidance technology in autonomous vehicles.

### Discussion of the Related Art

Generally, autonomous vehicles (or self-driving cars) stops when perceiving an object in a driving trajectory. Autonomous vehicles predict a traveling direction of an object to calculate a distance or a region for collision avoidance. However, when braking or avoidance of an autonomous vehicle is designed simply based on only a collision, it is difficult to smoothly perform vehicle traffic management in a complicated urban environment. Vehicle traffic management using vehicle-to-everything (V2X) communication is needed for smooth vehicle traffic management. However, conventional vehicle traffic management using V2X communication does not provide an autonomous driving strategy defined based on trajectory constraints which do not obstruct traffic of an adjacent lane despite a situation where an autonomous vehicle stops for avoiding a collision.

Moreover, because conventional vehicle traffic management using V2X communication is performed on nearby vehicles, it is unable to provide an autonomous driving strategy for various types of traffic participants such as bicycles and pedestrians.

### SUMMARY

An aspect of the present invention is directed to providing an infrastructure cooperative autonomous driving system and a method of generating trajectory constraints for collision avoidance in autonomous vehicles by using the system, which may provide autonomous driving according to an autonomous driving strategy defined in trajectory constraints generated based on object recognition information about a road map and various traffic participants.

To achieve these and other advantages and in accordance with the purpose of the invention, as embodied and broadly described herein, there is provided a method of generating trajectory constraints for collision avoidance in autonomous vehicles in an infrastructure cooperative autonomous driving system equipped in autonomous vehicles, the method including a step of comparing target trajectory information about an autonomous vehicle with future trajectory information including a future trajectory of a first object predicted from an edge infrastructure and a future trajectory of a second object predicted from the autonomous vehicle to calculate a time to collision and a collision point between each object and the autonomous vehicle by using a collision point calculator executed by a processor, a step of calculating a point, which is closest to the collision point and is not included in another lane area where the autonomous vehicle does not drive, of a trajectory of the autonomous vehicle as a safety point by using a safety point calculator executed by the processor, based on lane information included in a road map and the collision point, and a step of generating constraints defined by the time to collision, the collision point, and the safety point by using a constraint generator executed by the processor.

In an embodiment, the method may further include, before the step of calculating the time to collision and the collision point, a step of receiving a broadcast message including the future trajectory of the first object from the edge infrastructure through V2X through by using an on-board unit equipped in the autonomous vehicle and a step of extracting and obtaining the future trajectory of the first object from the broadcast message by using a data extractor executed by the processor.

In an embodiment, the broadcast message is a traveler information message, and a format of the traveler information message may include a basic field defined in V2X communication standard and an extended field where the future trajectory of the first object is recorded.

In an embodiment, the method may further include, before the step of calculating the time to collision and the collision point, a step of sensing the second object to generate sensor data by using a sensor device equipped in the autonomous vehicle and a step of predicting the future trajectory of the second object from the sensor data of the second object by using a future trajectory predictor executed by the processor, based on a deep learning model.

In an embodiment, the constraints may be defined as a rectangular area expressed by the time to collision, the collision point, and the safety point, in a coordinate system where a movement distance is an x axis and a time is a y axis in a trajectory of the autonomous vehicle.

In an embodiment, the trajectory constraints may be defined as a rectangular area where a line connecting first coordinates, consisting of an x-axis value obtained by subtracting a certain distance Δd from the safety point and a y-axis value obtained by subtracting a certain time Δt from the time to collision, to second coordinates consisting of an x-axis value obtained by adding the certain distance Δd to the collision point and a y-axis value obtained by adding the certain time Δt to the time to collision is a diagonal line.

In another aspect of the present invention, there is provided an infrastructure cooperative autonomous driving system equipped in autonomous vehicles includes an on-board unit configured to receive a first future trajectory of a first object from an edge infrastructure, a collision point calculator configured compare target trajectory information about the autonomous vehicle with future trajectory information including the first future trajectory of the first object and a future trajectory of the second object predicted from the autonomous vehicle to calculate a time to collision and a collision point between each object and the autonomous vehicle, a safety point calculator configured to calculate a point, which is closest to the collision point and is not included in another lane area where the autonomous vehicle does not drive, of a trajectory of the autonomous vehicle as a safety point, based on lane information included in a road map and the collision point, and a constraint generator configured to generate constraints defined by the time to collision, the collision point, and the safety point.

In an embodiment, the on-board unit may receive a broadcast message including the first future trajectory of the first object, the broadcast message may be a traveler information message, and a format of the traveler information message may include a basic field defined in V2X communication standard and an extended field where the first future trajectory of the first object is recorded.

In an embodiment, the infrastructure cooperative autonomous driving system may further include a data extractor configured to parse the traveler information message to extract the first future trajectory of the first object.

In an embodiment, the infrastructure cooperative autonomous driving system may further include a sensor device configured to sense the second object to generate sensor data and a future trajectory predictor configured to predict the future trajectory of the second object from the sensor data of the second object by using a deep learning model.

In an embodiment, the constraints may be defined as a rectangular area expressed by the time to collision, the collision point, and the safety point, in a coordinate system where a movement distance is an x axis and a time is a y axis in a trajectory of the autonomous vehicle.

In an embodiment, the infrastructure cooperative autonomous driving system may further include a trajectory optimization module configured to calculate a trajectory of the autonomous vehicle optimized based on an increase and a reduction in the rectangular area.

In another aspect of the present invention, there is provided a method of generating trajectory constraints for collision avoidance in autonomous vehicles in an infrastructure cooperative autonomous driving system, the method including a step of generating a first future trajectory of a first object and broadcasting a broadcast message including the first future trajectory by using an edge infrastructure, a step of receiving the broadcast message by using an on-board unit of an autonomous vehicle, a step of calculating a time to collision and a collision point between each object and the autonomous vehicle by using a collision point calculator of the autonomous vehicle, based on future trajectory information including the first future trajectory of the first object included in the broadcast message and a future trajectory of a second object predicted from the autonomous vehicle, a step of calculating a safety point by using a safety point calculator of the autonomous vehicle, based on lane information about a road map and the collision point, and a step of generating constraints defined by the time to collision, the collision point, and the safety point by using a constraint generator of the autonomous vehicle.

In an embodiment, the safety point may be a point, which is closest to the collision point and is not included in another lane area where the autonomous vehicle does not drive, of a trajectory of the autonomous vehicle.

In an embodiment, the constraints may be defined as a rectangular area expressed by the time to collision, the collision point, and the safety point, in a coordinate system where a movement distance is an x axis and a time is a y axis in a trajectory of the autonomous vehicle.

In an embodiment, the broadcasting of the broadcast message may include a step of sensing the first object to generate sensor data by using a sensor device of the edge infrastructure, a step of generating the first future trajectory of the first object from the sensor data by using an edge computer of the edge infrastructure, based on a deep learning model, a step of generating a broadcast message including the first future trajectory by using the edge computer of the edge infrastructure, and a step of broadcasting the broadcast message by using a road side unit of the edge infrastructure.

In an embodiment, one of the first object and the second object may be a vehicle, and the other object is a moving object other than a vehicle.

### BRIEF DESCRIPTION OF THE DRAWINGS

FIG. 1 is a block diagram for describing an infrastructure cooperative autonomous driving (ICAD) system according to an embodiment of the present invention.

FIG. 2 is a diagram for describing an edge infrastructure which is an edge infrastructure included in the ICAD system illustrated in FIG. 1 and is installed in a real environment.

FIG. 3 is a diagram for describing a structure of an extended traveler information message (TIM) according to an embodiment of the present invention.

FIG. 4 is a block diagram of a cooperative recognition device according to an embodiment of the present invention.

FIG. 5 is a configuration diagram of a trajectory constraint generating module illustrated in FIG. 4.

FIG. 6 is a diagram for describing trajectory constraints appearing in a coordinate system according to an embodiment of the present invention.

FIG. 7 is a flowchart for describing a method of generating trajectory constraints for collision avoidance in autonomous vehicles by using the ICAD system according to an embodiment of the present invention.

### DETAILED DESCRIPTION OF THE INVENTION

In an embodiment of the present invention, an infrastructure cooperative autonomous driving (ICAD) system for enhancing a vision capacity by using an edge infrastructure may be provided for obtaining object recognition information about various types of traffic participants.

An ICAD system according to an embodiment of the present invention may include autonomous vehicles which participate in V2I broadcasting of an edge infrastructure providing object perception (recognition) information. The autonomous vehicles may establish an autonomous driving policy from the object recognition information collected through V2I broadcasting.

The autonomous driving policy may be defined based on trajectory constraints generated according to an embodiment of the present invention. The autonomous driving policy defined based on the trajectory constraints may impact on a trajectory of an autonomous vehicle to enhance safety.

An autonomous driving system according to an embodiment of the present invention may have an adaptive structure which may easily extend in a conventional autonomous driving system and may support autonomous driving on various types of traffic participants including vehicles and pedestrians.

Hereinafter, example embodiments of the invention will be described in detail with reference to the accompanying drawings. In describing the invention, to facilitate the entire understanding of the invention, like numbers refer to like elements throughout the description of the figures, and a repetitive description on the same element is not provided.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

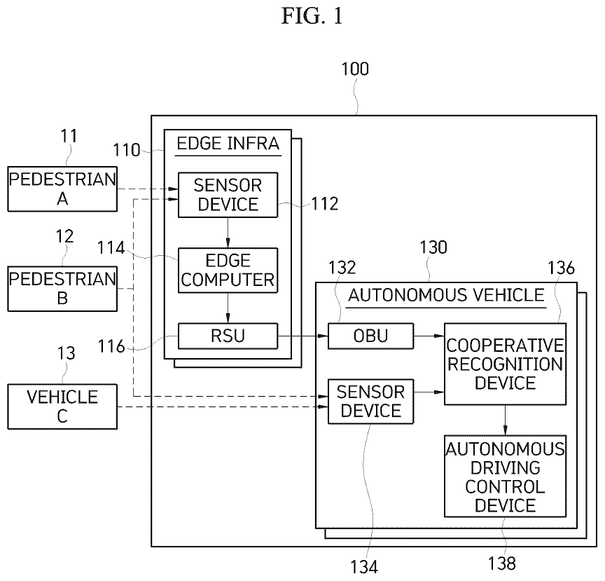

FIG. 1 is a block diagram for describing an ICAD system 100 according to an embodiment of the present invention.

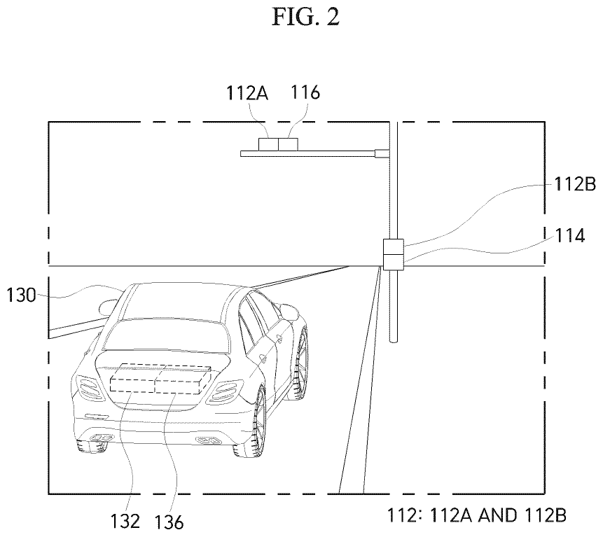

FIG. 2 is a diagram for describing an edge infrastructure which is an edge infrastructure included in the ICAD system 100 illustrated in FIG. 1 and is installed in a real environment.

Referring to FIG. 1, because autonomous driving is more difficult in a partially observable Markov decision process (POMDP) environment than a Markov decision process (MDP) environment, the ICAD system 100 according to an embodiment of the present invention may remove a blind spot to enhance safety.

Unlike a vehicle-to-vehicle (V2V)-based system, the ICAD system 100 according to an embodiment of the present invention may install an edge infrastructure in hazardous areas to increase visibility.

Although there are V2I and V2X systems using a conventional edge infrastructure, such a system mainly performs vehicle traffic management. On the other hand, the ICAD system 100 according to an embodiment of the present invention may adopt a safe autonomous driving strategy based on all traffic participants including pedestrians.

The ICAD system 100 according to an embodiment of the present invention may include a plurality of edge infrastructures 110 and a plurality of autonomous vehicles 130.

When an environment including two pedestrians 11 and 12 and one vehicle 13 is assumed, the edge infrastructure 110 according to an embodiment of the present invention may sense the two pedestrians 11 and 12, and the autonomous driving vehicle 130 according to an embodiment of the present invention may sense the one vehicle 13. On the other hand, the edge infrastructure 110 may sense the one pedestrian 11 and the one vehicle 13, the autonomous vehicle 130 may sense the one pedestrian 12. In FIG. 1, a case where the edge infrastructure and the autonomous vehicle sense moving objects such as the pedestrians 11 and 12 and the vehicle 13 is illustrated, and the present invention is not limited thereto and the edge infrastructure and the autonomous vehicle may sense static objects such as lanes, crosswalks, traffic lights, and traffic signs.

The autonomous vehicle 130 according to an embodiment of the present invention may perceive the objects 11, 12, and 13 which are various types of traffic participants, through cooperative recognition (perception) with the edge infrastructure 110.

The edge infrastructure 110 may recognize the nearby objects 11 and 12 and may broadcast the object recognition information obtained by recognizing the nearby objects 11 and 12.

The autonomous vehicle 130 may receive the object recognition information from the edge infrastructure 110 and may combine the received object recognition information and object recognition information which is obtained by independently recognizing the vehicle 13 by using the autonomous vehicle 130.

The edge infrastructure 110 may be installed in hazardous areas and road sides and may support a vision for the nearby autonomous vehicle 130. To this end, the edge infrastructure 110 may include, for example, a sensor device 112, an edge computer 114, and a road side unit (RSU) 116.

The sensor device 112 may include a camera 112A and a LiDAR 112B for sensing the objects 11 and 12 such as pedestrians. The edge computer 114 may process data, sensed by the sensor device 112, into object recognition (perception) information. The RSU 116 may be a communication unit for performing data communication and may broadcast the object recognition information obtained through processing by the edge computer 114.

The edge computer 114 may include at least one processor, at least one memory, and at least one input/output (I/O) interface. The processor may include, for example, at least one at least one central processing unit (CPU), at least one graphics processing unit (GPU), at least one micro controller unit (MCU), and at least one system on chip (SoC). The memory may include a volatile memory or a non-volatile memory.

The data sensed by the sensor device 112 may not be transmitted in a raw form and may be processed into the object recognition information for decreasing the amount of communication by using the edge computer 114, and then, may generate a broadcast message including the object recognition information.

The RSU 116 may be a communication unit which broadcasts the broadcast message to the nearby autonomous vehicles 130 through V2X communication (for example, LTE C-V2X communication). The broadcast message may be a message for providing real-time traffic information and road conditions and may be a traveler information message (TIM) which is defined in V2X communication standard (for example, society of automotive engineers (SAE) international standard).

In an embodiment of the present invention, an extended TIM for the ICAD system 100 may be provided. The extended TIM according to an embodiment of the present invention may be obtained by combining a basic TIM, defined in V2X communication standard, with an additional data frame for processing the object recognition information obtained by the edge infrastructure 110.

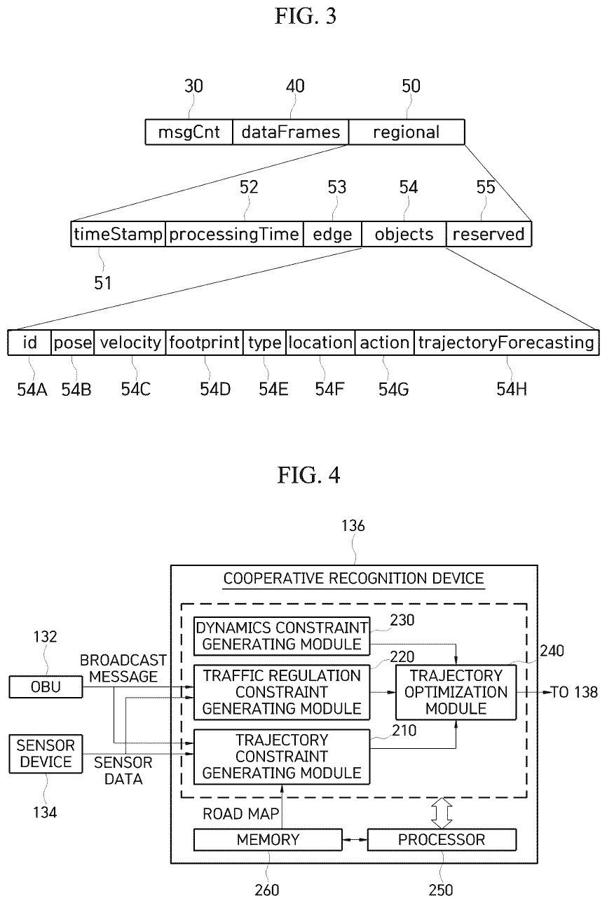

FIG. 3 is a diagram for describing a structure of an extended TIM according to an embodiment of the present invention.

Referring to FIG. 3, the extended TIM according to an embodiment of the present invention may be for extending a TIM of SAE J2735 disclosed in SAE international standard. The extended TIM may include a msgCnt field 30, a data field 40, and a regional field 50.

A message generating order may be recorded in the msgCnt field 30. Although not shown, the data field 40 may include a frameType field, an msgId field, a startTime field, a durationTime field, a priority field, and a regions field. The type of a TIM may be recorded in the frameType field. A message ID may be recorded in the msgId field. A message generating time may be recorded in the startTime field. A message duration may be recorded in the durationTime field. An appearance priority in the TIM may be recorded in the priority field. A latitude and a longitude of an anchor may be recorded in the regions field.

The regional field 50 may be an extension field, and the object recognition information recognized by the edge infrastructure 110 may be recorded in the regional field 50. In detail, regional field 50 may include a timeStamp field 51, a processingTime field 52, an edge field 53, an objections field 54, and a reserved field 55.

A message transmission time may be recorded in the timeStamp field 51. A calculation time may be recorded in the processingTime field 52. Information (for example, an identification (ID) of an edge infrastructure, reference coordinate system information, and coordinates of an edge infrastructure in a reference coordinate system) about an edge infrastructure which has transmitted a message may be recorded in the edge field 53. The object recognition information recognized by the edge infrastructure 110 may be recorded in the objections field 54. The objections field 54 may include, for example, an id field 54A where an object ID is recorded, a field 54B where an object pose is recorded, a field 54C where an object speed is recorded, a field 54D where an object type is recorded, a field 54E where object type classification is recorded, a field 54F where object position classification is recorded, a field 54G where object behavior classification is recorded, and a field 54H where future trajectory prediction information is recorded.

The object recognition information recorded in the objections field 54 may be information which is obtained by the edge computer 114 analyzing the data sensed by the sensor device 112. For example, the edge computer 114 may execute an artificial intelligence (AI) model such as a pre-learned deep learning model to infer the object recognition information from the data sensed by the sensor device 112. Here, the object recognition information may include at least one of the object speed, the object type, the object type classification, the object position classification, the object behavior classification, and the future trajectory prediction information, which are recorded in the objections field 54.

Referring again to FIGS. 1 and 2, the autonomous vehicle 130 may combine the object recognition information, recognized by the autonomous vehicle 130, with object recognition information included in the extended TIM received from the edge infrastructure 110 through the RSU 116 to perform real-time cooperative recognition (perception).

Because the object recognition information recognized by the autonomous vehicle 130 and the object recognition information recognized by the edge infrastructure 110 are generated at different times, such an information sharing strategy may increase a load of a wireless channel, but the ICAD system 100 may decrease an edge computing operation of the edge computer 114 included in the edge infrastructure 110 and the amount of information transmission through the extended TIM. Accordingly, the ICAD system 100 may perform real-time cooperative recognition.

For real-time cooperative recognition, the autonomous vehicle 130 may include an on-board unit (OBU) 132, a sensor device 134, a cooperative recognition device 136, and an autonomous driving control device 138.

The OBU 132 may be a device which receives a broadcast message (the extended TIM) from the nearby RSU 116 and transfers the broadcast message to the cooperative recognition device 136 and may be a communication unit which is designed to support V2X communication.

The sensor device 134 may be a device which senses the nearby object 13 of the autonomous vehicle 130 and may include at least one of a LiDAR sensor, a camera, and an ultrasound sensor. The autonomous vehicle 130 may independently sense a nearby region by using sensor device 134.

Cooperative recognition may be needed for combining the object recognition information, obtained by the edge infrastructure 110, with the data obtained by the sensor device 134 of the autonomous vehicle 130, and such cooperative recognition may be performed by the cooperative recognition device 136.

The autonomous driving control device 138 may provide autonomous driving control for avoiding collisions with the objects 11, 12, and 13 through an expanded field of view, based on cooperative recognition of the cooperative recognition device 136.

The autonomous vehicle 130 should establish a strategy for avoiding collisions with various types of traffic participants such as pedestrians or bicycles as well as vehicles. To this end, generalization which diverges from existing strategies considering only a vehicle as a collision avoidance target may be needed.

The cooperative recognition device 136 according to an embodiment of the present invention may introduce a driving policy expressed as trajectory constraints through cooperative recognition to establish a generalized strategy for avoiding collisions with various types of traffic participants regardless of the number and type of objects, and the autonomous driving control device 138 may control autonomous driving, based on the established generalized strategy.

Hereinafter, the cooperative recognition device 136 will be described in detail with reference to FIG. 4.

FIG. 4 is a block diagram of the cooperative recognition device 136 according to an embodiment of the present invention.

Referring to FIG. 4, the cooperative recognition device 136 may generate trajectory constraints through cooperative recognition which combines object recognition information, recognized by the edge infrastructure, with object recognition information independently recognized by the autonomous vehicle 130 and may optimize a trajectory of the autonomous vehicle 130, based on the generated trajectory constraints.

To this end, the cooperative recognition device 136 according to an embodiment of the present invention may include a trajectory constraint generating module 210 and a trajectory optimization module 240.

The trajectory constraint generating module 210 may be the object recognition information recognized by the edge infrastructure 110 and may generate trajectory constraints for avoiding collisions with the objects 11, 12, and 13 without obstructing a traffic flow of a different lane by the autonomous vehicle 130, based on the object recognition information included in the broadcast message (for example, the extended TIM) received from the edge infrastructure 110 through the OBU 132 and sensor data and a road map (for example, a high definition (HD) map) independently sensed by the autonomous vehicle 130 through the sensor unit 134. The trajectory optimization module 240 may generate an optimized target trajectory from a target trajectory of the autonomous vehicle 130, based on the generated trajectory constraints.

The cooperative recognition device 136 according to another embodiment of the present invention may further include a traffic regulation constraint generating module 220. The traffic regulation constraint generating module 220 may generate constraints for allowing a trajectory of the autonomous vehicle 130 to observe traffic regulations, based on traffic regulations and data obtained by sensing static objects such as lanes, crosswalks, traffic lights, and traffic signs by using the sensor devices 112 and 134. In another embodiment, the trajectory optimization module 240 may generate an optimized target trajectory from a target trajectory of the autonomous vehicle 130, based on the trajectory constraints generated by the trajectory constraint generating module 210 and constraints for observing the traffic regulations generated by the traffic regulation constraint generating module 220.

The cooperative recognition device 136 according to another embodiment of the present invention may further include a dynamics constraint generating module 230. The dynamics constraint generating module 230 may generate constraints for allowing a trajectory of the autonomous vehicle 130 to observe dynamics, based on a measurement result of each of a pose, a speed, and an acceleration of the autonomous vehicle 130 and the spec (for example, a length, a width, a highest speed, and a lowest speed of a vehicle) of the autonomous vehicle 130. In another embodiment, the trajectory optimization module 240 may generate the optimized target trajectory from the target trajectory of the autonomous vehicle 130, based on the trajectory constraints generated by the trajectory constraint generating module 210, the constraints for observing the traffic regulations generated by the traffic regulation constraint generating module 220, and constraints for observing dynamics generated by the dynamics constraint generating module 230.

The cooperative recognition device 136 according to another embodiment of the present invention may further include a processor 160 and a memory 260. The processor 250 may control operations of the trajectory constraint generating module 210, the traffic regulation constraint generating module 220, the dynamics constraint generating module 230, and the trajectory optimization module 240. In a case where each of the modules 210 to 240 is implemented as a software module, the processor 260 may execute operations of the modules 210 to 240, based on instructions stored in the memory 260. Also, the memory 260 may store a road map and may provide the stored road map to the trajectory constraint generating module 210, based on control by the processor 260.

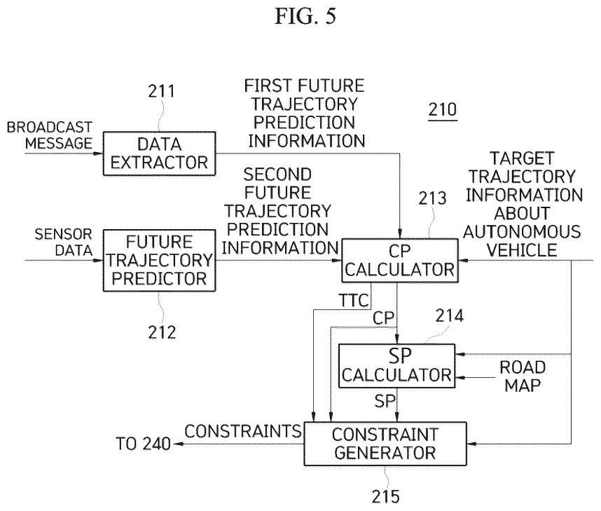

FIG. 5 is a configuration diagram of the trajectory constraint generating module 210 illustrated in FIG. 4.

Referring to FIG. 5, the trajectory constraint generating module 210 according to an embodiment of the present invention may include a data extractor 211, a future trajectory predictor 212, a collision point calculator 213, a safety point calculator 214, and a constraint generator 215.

The data extractor 211 may extract future trajectory prediction information (hereinafter referred to as first future trajectory prediction information) about the objects 11 and 12 included in the broadcast message (for example, an extended TIM) received from the edge infrastructure 110 through the OBU 132 (see FIG. 1). For example, the data extractor 211 may parse the broadcast message (for example, an extended TIM) illustrated in FIG. 3 to extract the first future trajectory prediction information recorded in the field 54H of the broadcast message. The data extractor 211 may input the extracted first future trajectory prediction information to the collision point calculator 213.

The future trajectory predictor 212 may predict a future trajectory (hereinafter referred to as second future trajectory prediction information) of each of the objects 12 and 13 recognized by the sensor device 134, based on the sensor data from the sensor device 134. A deep learning model pre-learned to predict the future trajectory may be used for predicting the second future trajectory prediction information, based on a pose estimation algorithm or the sensor data.

The collision point calculator 213 may compare the first and second future trajectory prediction information about the objects 11 to 13 and the target trajectory information about the autonomous vehicle 130 to calculate collision points (CPs) and a time to collision (TTC) of each object and the autonomous vehicle 130.

The safety point calculator 214 may calculate safety points (SPs) which do not collide with the objects 11 to 13, based on lane information included in the road map (for example, an HD map) and the CP. In this case, the calculated SP may be a point of a trajectory of the autonomous vehicle, which is closest to the CP and is not included in a lane area where the vehicle 13 (see FIG. 1) is driving. Accordingly, the safety point calculator 214 may calculate an SP which does not obstruct a traffic flow of the other lane area. As described above, the safety point calculator 214 may use lane information included in the road map, so as to calculator the SP of the trajectory of the autonomous vehicle which is not included in the other lane area.

The constraint generator 215 may generate trajectory constraints, based on the TTC and the CP calculated by the CP calculator 213 and the SP calculated by the SP calculator 214. The trajectory constraints may be determined by the TTC, the CP, and the SP.

A general condition for avoiding collisions in the CP may be a condition where the autonomous vehicle 130 does not pass through the CP in the TTC. For example, the autonomous vehicle 130 may avoid collisions when the autonomous vehicle 130 passes through the CP at a previous time “TTC−Δt” of the TTC or a subsequent time “TTC+Δt” of the TTC. That is, the autonomous vehicle 130 may avoid collisions in the CP by performing control so that a speed of the autonomous vehicle 130 is higher or lower than a target object (13 of FIG. 1).

However, when a speed is simply reduced with respect to the CP, the autonomous vehicle 130 may stop at the middle of the intersection. Such an action may potentially cause traffic congestion and accidents.

To solve such an issue, a strategy of the ICAD system 100 may combine the CP with a concept of the SP. That is, the strategy may be a strategy which is for preventing collisions, based on the SP as well as the CP.

When future trajectory prediction is sufficiently accurate, the autonomous vehicle 130 may avoid an area defined by a point pose “p∈[SP−Δd, CP+Δd]” at a time “t∈[TTC−Δt, TTC+Δt]” without the occurrence of any collision. That is, the policy may be configured with trajectory constraints capable of being expressed as a series of rectangular area in a time and distance coordinate system.

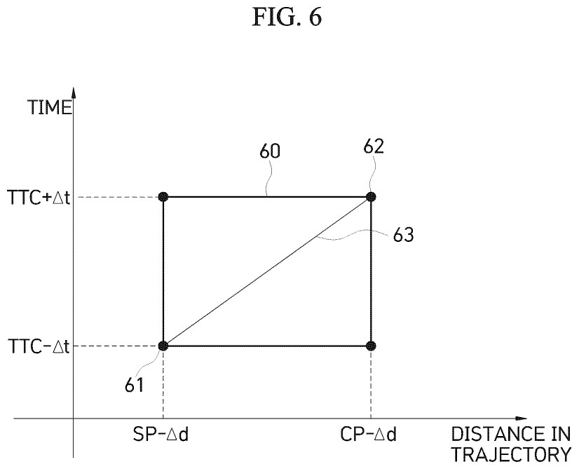

FIG. 6 is a diagram for describing trajectory constraints appearing in a coordinate system according to an embodiment of the present invention.

Referring to FIG. 6, the coordinate system may be a coordinate system where an abscissa axis (an x axis) represents a movement distance of a trajectory of the autonomous vehicle 130 and the ordinate axis (a y axis) represents a time. The trajectory constraints may be defined as a rectangular area 60 where a line 63 connecting coordinates (SP−Δd, TTC−Δt) to coordinates (CP+Δd, TTC+Δt) is a diagonal line in the time and distance coordinate system. Here, SP−Δd may denote an x-axis coordinate value obtained by subtracting a certain distance Δd from the SP, TTC−Δt may denote a y-axis coordinate value obtained by subtracting a certain time Δt from the TTC, and CP+Δd may denote an x-axis coordinate value obtained by adding the certain distance Δd to the CP. Also, TTC+Δt may denote a y-axis coordinate value obtained by adding the certain time Δt to the TTC.

An operation of generating the trajectory constraints may denote an operation of generating an obstacle set which is a configuration space of the autonomous space. An area where a collision with a vehicle occurs in a space expressed based on a position, a direction angle, and a speed may be an obstacle area. An obstacle may be generally expressed as a vector or a raster. In the present embodiment, the operation of generating the trajectory constraints may not limit the form of obstacles, but may be specified as a pose “p∈[SP−Δd, CP+*Δd] & time t∈[TTC−Δt, TTC+Δt]” in a coordinate system where a trajectory movement distance is the abscissa axis (an x axis) and a time is the ordinate axis (a y axis). That is, a sum set of the areas may be trajectory constraints.

When objects (11 to 13 of FIG. 1) show an emergency or aggressive behavior, the constraint generator 215 may enlarge a rectangular area 60 representing the trajectory constraints to transfer to the trajectory optimization module 240. The trajectory optimization module 240 may optimize a target trajectory of the autonomous vehicle 130 so that the autonomous vehicle 130 adopts a yielding behavior, based on trajectory constraints expressed as the enlarged rectangular area.

A strategy of the ICAD system 100 may be applied regardless of the kind and number of objects. That is, the strategy of the ICAD system 100 according to an embodiment of the present invention may generalize an object such as a pedestrian or a bicycle to consider collision avoidance, unlike standalone vehicle-oriented strategies or communication-based strategies.

Moreover, when an object is urgent or aggressive like emergency vehicles, jaywalking pedestrians, and reckless driving vehicles, the ICAD system 100 may calculate a yielding trajectory. Also, a conventional autonomous driving system may be easily extended to the ICAD system according to an embodiment of the present invention, based on a structure where object recognition information recognized by an edge infrastructure and object recognition information recognized by an autonomous vehicle are transferred as trajectory constraints expressed as a rectangular area in a time and distance coordinate system.

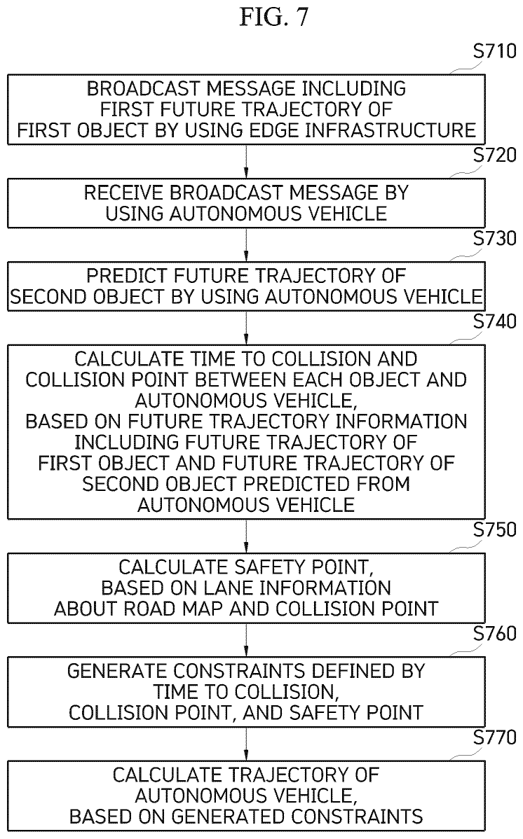

FIG. 7 is a flowchart for describing a method of generating trajectory constraints for collision avoidance in autonomous vehicles by using the ICAD system according to an embodiment of the present invention.

Referring to FIG. 7, first, in step S710, a process of generating a first future trajectory of each of the first objects 11 and 12 and broadcasting a broadcast message including the first future trajectory by using the edge infrastructure 110 may be performed.

In an embodiment, a process of sensing the first objects 11 and 12 to generate sensor data by using the sensor device 112 of the edge infrastructure 110 so as to broadcast the broadcast message may be performed. Subsequently, a process of generating a future trajectory of each of the first objects 11 and 12 from the sensor data by using a deep learning model in the edge computer 114 of the edge infrastructure 110 may be performed. Subsequently, a process of generating a broadcast message (the extended TIM of FIG. 3) including the future trajectory of each of the first objects 11 and 12 by using the edge computer 114 of the edge infrastructure 110 may be performed.

In an embodiment, the broadcast message may be a traveler information message, and the traveler information message may be configured in a format which is configured to include a basic field defined in V2X communication standard and an extended field (50 of FIG. 3) where the future trajectory of the first object is recorded.

Subsequently, in step S720, a process of receiving the broadcast message including the future trajectory of the first object from the edge infrastructure 110 through V2X communication by using the OBU 132 equipped in the autonomous vehicle 130 may be performed.

In an embodiment, step S720 may include a process of extracting the future trajectory of the first object from the broadcast message to input to the CP calculator 213 by using the data extractor 211 executed by the processor (250 of FIG. 4).

Subsequently, in step S730, a process of independently predicting the future trajectory of each of the second objects 12 and 13 of the autonomous vehicle 130 may be performed.

In an embodiment, step S730 may a process of sensing the second objects 12 and 13 to generate sensor data by using the sensor device 134 equipped in the autonomous vehicle 130 and a process of predicting the future trajectory of the second object from the sensor data of the second objects 12 and 13 by using a deep learning model in the future trajectory predictor (212 of FIG. 5) executed by the processor (250 of FIG. 4).

Subsequently, in step S740, a process of comparing target trajectory information about the autonomous vehicle with future trajectory information including the future trajectory of the first object predicted from the edge infrastructure 110 and the future trajectory of the second object predicted from the autonomous vehicle 130 to calculate a time to collision (TTC) and a collision point (CP) between each object and the autonomous vehicle 130 by using the CP calculator (213 of FIG. 5) executed by the processor (250 of FIG. 4) may be performed. Here, one of the first and second objects may be a vehicle, and the other may be a moving object (for example, a pedestrian, a bicycle, etc.) other than a vehicle.

Subsequently, in step S750, a process of calculating a point, which is closest to the collision point (CP) and is not included in a lane area where the autonomous vehicle 130 does not drive, of the target trajectory of the autonomous vehicle 130 as a safety point (SP) by using the SP calculator (214 of FIG. 5) executed by the processor (250 of FIG. 4), based on lane information included in a road map and the collision point (CP).

Subsequently, in step S760, a process of generating constraints defined by the time to collision (TTC), the collision point (CP), and the safety point (SP) by using the constraint generator executed by the processor may be performed.

In an embodiment, the constraints may be defined as the rectangular area 60 expressed by the time to collision, the collision point, and the safety point in the coordinate system 60 where a movement distance is an x axis and a time is a y axis in the target trajectory of the autonomous vehicle 130.

In another embodiment, the trajectory constraints may be defined as a rectangular area (60 of FIG. 6) where a line (63 of FIG. 6) connecting first coordinates 61, consisting of an x-axis value obtained by subtracting a certain distance Δd from the safety point (SP) and a y-axis value obtained by subtracting a certain time Δt from the time to collision (TTC), to second coordinates (62 of FIG. 6) consisting of an x-axis value obtained by adding the certain distance Δd to the collision point (CP) and a y-axis value obtained by adding the certain time Δt to the time to collision (TTC) is a diagonal line.

Subsequently, in step S770, a process of calculating a target trajectory of the autonomous vehicle 130 optimized based on an increase and a reduction in the rectangular area (60 of FIG. 6) by using the trajectory optimization module (240 of FIG. 4) executed by the processor (250 of FIG. 4) may be performed.

As described above, the ICAD system 100 may provide cooperative recognition based on the edge infrastructure 110 having an edge computing function so as to widen a field of view of an autonomous vehicle. Also, the ICAD system 100 may use an extended TIM based on V2X communication standard, so as to broadcast a future trajectory of an object recognized by an edge infrastructure. Also, the ICAD system 100 may introduce a safety point to decrease an influence of an action, caused by collision avoidance, on a traffic flow of another lane.

According to the embodiments of the present invention, autonomous driving may be performed according to an autonomous driving strategy defined in trajectory constraints generated based on object recognition information about a road map and various traffic participants, and thus, because collision avoidance does not obstruct traffic of an adjacent lane despite a situation where an autonomous vehicle stops for avoiding a collision, the stability of autonomous driving may increase and vehicle traffic management may be easily performed.

Moreover, the autonomous driving strategy may be provided in a constraint form expressed in a trajectory time-space coordinate system, and thus, may be applied to all kinds of autonomous driving systems requiring trajectory optimization.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of generating trajectory constraints for collision avoidance in autonomous vehicles in an infrastructure cooperative autonomous driving system equipped in autonomous vehicles, the method comprising:
a step of comparing target trajectory information about an autonomous vehicle with future trajectory information including a future trajectory of a first object predicted from an edge infrastructure and a future trajectory of a second object predicted from the autonomous vehicle to calculate a time to collision and a collision point between each object and the autonomous vehicle by using a collision point calculator executed by a processor;
a step of calculating a point, which is closest to the collision point and is not included in another lane area where the autonomous vehicle does not drive, of a trajectory of the autonomous vehicle as a safety point by using a safety point calculator executed by the processor, based on lane information included in a road map and the collision point; and
a step of generating constraints defined by the time to collision, the collision point, and the safety point by using a constraint generator executed by the processor.

2. The method of claim 1, further comprising, before the step of calculating the time to collision and the collision point,
a step of receiving a broadcast message including the future trajectory of the first object from the edge infrastructure through V2X through by using an on-board unit equipped in the autonomous vehicle; and
a step of extracting and obtaining the future trajectory of the first object from the broadcast message by using a data extractor executed by the processor.

3. The method of claim 2, wherein the broadcast message is a traveler information message, and
a format of the traveler information message comprises a basic field defined in V2X communication standard and an extended field where the future trajectory of the first object is recorded.

4. The method of claim 1, further comprising, before the step of calculating the time to collision and the collision point,
a step of sensing the second object to generate sensor data by using a sensor device equipped in the autonomous vehicle; and
a step of predicting the future trajectory of the second object from the sensor data of the second object by using a future trajectory predictor executed by the processor, based on a deep learning model.

5. The method of claim 1, wherein the constraints are defined as a rectangular area expressed by the time to collision, the collision point, and the safety point, in a coordinate system where a movement distance is an x axis and a time is a y axis in a trajectory of the autonomous vehicle.

6. The method of claim 1, wherein the trajectory constraints are defined as a rectangular area where a line connecting first coordinates, consisting of an x-axis value obtained by subtracting a certain distance Δd from the safety point and a y-axis value obtained by subtracting a certain time Δt from the time to collision, to second coordinates consisting of an x-axis value obtained by adding the certain distance Δd to the collision point and a y-axis value obtained by adding the certain time Δt to the time to collision is a diagonal line.

7. An infrastructure cooperative autonomous driving system equipped in autonomous vehicles, the infrastructure cooperative autonomous driving system comprising:
an on-board unit configured to receive a first future trajectory of a first object from an edge infrastructure;
a collision point calculator configured compare target trajectory information about the autonomous vehicle with future trajectory information including the first future trajectory of the first object and a future trajectory of the second object predicted from the autonomous vehicle to calculate a time to collision and a collision point between each object and the autonomous vehicle;
a safety point calculator configured to calculate a point, which is closest to the collision point and is not included in another lane area where the autonomous vehicle does not drive, of a trajectory of the autonomous vehicle as a safety point, based on lane information included in a road map and the collision point; and
a constraint generator configured to generate constraints defined by the time to collision, the collision point, and the safety point.

8. The infrastructure cooperative autonomous driving system of claim 7, wherein the on-board unit receives a broadcast message including the first future trajectory of the first object,
the broadcast message is a traveler information message, and
a format of the traveler information message comprises a basic field defined in V2X communication standard and an extended field where the first future trajectory of the first object is recorded.

9. The infrastructure cooperative autonomous driving system of claim 8, further comprising a data extractor configured to parse the traveler information message to extract the first future trajectory of the first object.

10. The infrastructure cooperative autonomous driving system of claim 7, further comprising:
a sensor device configured to sense the second object to generate sensor data; and
a future trajectory predictor configured to predict the future trajectory of the second object from the sensor data of the second object by using a deep learning model.

11. The infrastructure cooperative autonomous driving system of claim 7, wherein the constraints are defined as a rectangular area expressed by the time to collision, the collision point, and the safety point, in a coordinate system where a movement distance is an x axis and a time is a y axis in a trajectory of the autonomous vehicle.

12. The infrastructure cooperative autonomous driving system of claim 11, further comprising a trajectory optimization module configured to calculate a trajectory of the autonomous vehicle optimized based on an increase and a reduction in the rectangular area.

13. A method of generating trajectory constraints for collision avoidance in autonomous vehicles in an infrastructure cooperative autonomous driving system, the method comprising:
a step of generating a first future trajectory of a first object and broadcasting a broadcast message including the first future trajectory by using an edge infrastructure;
a step of receiving the broadcast message by using an on-board unit of an autonomous vehicle;
a step of calculating a time to collision and a collision point between each object and the autonomous vehicle by using a collision point calculator of the autonomous vehicle, based on future trajectory information including the first future trajectory of the first object included in the broadcast message and a future trajectory of a second object predicted from the autonomous vehicle;
a step of calculating a safety point by using a safety point calculator of the autonomous vehicle, based on lane information about a road map and the collision point; and
a step of generating constraints defined by the time to collision, the collision point, and the safety point by using a constraint generator of the autonomous vehicle.

14. The method of claim 13, wherein the safety point is a point, which is closest to the collision point and is not included in another lane area where the autonomous vehicle does not drive, of a trajectory of the autonomous vehicle.

15. The method of claim 13, wherein the constraints are defined as a rectangular area expressed by the time to collision, the collision point, and the safety point, in a coordinate system where a movement distance is an x axis and a time is a y axis in a trajectory of the autonomous vehicle.

16. The method of claim 13, wherein the broadcasting of the broadcast message comprises:
a step of sensing the first object to generate sensor data by using a sensor device of the edge infrastructure;
a step of generating the first future trajectory of the first object from the sensor data by using an edge computer of the edge infrastructure, based on a deep learning model;
a step of generating a broadcast message including the first future trajectory by using the edge computer of the edge infrastructure; and
a step of broadcasting the broadcast message by using a road side unit of the edge infrastructure.

17. The method of claim 13, wherein one of the first object and the second object is a vehicle, and the other object is a moving object other than a vehicle.
